(19) United States
(12) Patent Application Publication
(10) Pub. No.: US 2004/0021692 A1
(43) Pub. Date: Feb. 5, 2004

(54) Method for controlling a multimedia document display

(76) Inventors: Christophe Comps, Cestas (FR); Daniel Boudet, Paris (FR); Xavier Sarremejean, Vaureal (FR)

Correspondence Address: SUGHRUE MION, PLLC, 2100 PENNSYLVANIA AVENUE, N.W., WASHINGTON, DC, 20037, US

(21) Appl. No.: 10/380,065

(22) PCT Filed: Sep. 13, 2001
(86) PCT No.: PCT/FR01/02843

(30) Foreign Application Priority Data
Sep. 14, 2000 (FR) 00/11712

(51) Int. Cl. G09G 5/00

(52) U.S. Cl. 345/781

(57) ABSTRACT

The invention concerns a method for displaying data on a display screen, comprising at least two zones, respectively a first and a second zone for data display, the position of the second zone being determined relative to a reference point in accordance with a first location relationship. The invention is characterised in that said reference point is determined relative to said first zone, in accordance with a second location relationship.

The present invention concerns a method of controlling the display of a multimedia document. It applies to communication terminals, for example, or to be more precise to mobile radio terminals, pocket computers or other equipment that can have multimedia capabilities, in the situation where the dimensions of the display screen are not known.

The expression “multimedia file” generally refers to the integration of different types of data (such as pictures, sound, text, etc.) in the same file. Each type of data is contained in a data track. Each track is organized in the form of a series of commands. Each track is processed by a different microprocessor. Each microprocessor executes commands at the same time as the others and can present the data to a user of an equipment with multimedia capabilities via different interfaces (such as a loudspeaker for sound data and a display screen for picture or text data). Data to be displayed on a screen and belonging to different tracks must be displayed in different areas of the screen. These areas are also referred to as video areas.

In the prior art, video areas can be displayed using the technique used by Apple or Microsoft to display all data on a computer screen.

FIG. 1 represents a screen of a computer using this display technique. This screen 10 must display a multimedia file comprising two tracks, one containing picture data to be displayed in a first area 20 and the other containing text data to be displayed in a second area 30. The screen has a height X=600 pixels, also referred to as screen points, and a width Y=800 pixels. Each pixel is identified in a system of axes consisting of a center O of coordinates x=0 and y=0 in the top left-hand corner of the screen, a horizontal axis 40 at the top of the screen and a vertical axis 50 on the left-hand side of the screen.

The first area 20, with four corners, is defined by the coordinates (x′,y′) of the corner O′ in the top left-hand corner of the area 20, by its height H1=200 pixels, and by its width L1=100 pixels. If the user wishes to display this image at the top of the screen and 50 pixels from the left-hand edge 50 of the screen, then the coordinates (x′=50, y′=0), H1=200 and L1=100 are transmitted to the screen manager. The screen manager, generally an operating system, then displays the area 20.

The second area 30, with four corners, is defined by the coordinates (x″,y″) of the corner O′ in the top left-hand corner of the area 30, by its height H2=30 pixels and by its width L2=150 pixels. If the user wishes to display this image in the bottom right-hand corner of the screen, against the left-hand edge 50 of the screen, then the coordinates (x″=0, y″=600−30), H2=30 and L2=150 are transmitted to the screen manager. The screen manager then displays the area 30.

To display areas using this technique it is necessary to obtain from the operating system the size of the screen and to calculate coordinates for positioning the areas.

One solution to this problem would be to use the hypertext markup language (HTML) used to describe HTML pages downloaded from an Internet server. Where possible, given the size of the screen, this language gives priority to displaying video areas in full as a function of the available space, without calculating coordinates. However, this solution cannot identically reproduce the original position of these areas on the page before downloading.

The object of the present invention is therefore to display different video areas in conformity with their original presentation and the display of all of the information that they contain.

The invention and its advantages will become more clearly apparent in the course of the following description, which refers to the accompanying drawings.

FIG. 1, already described, represents a computer screen and a prior art display technique.

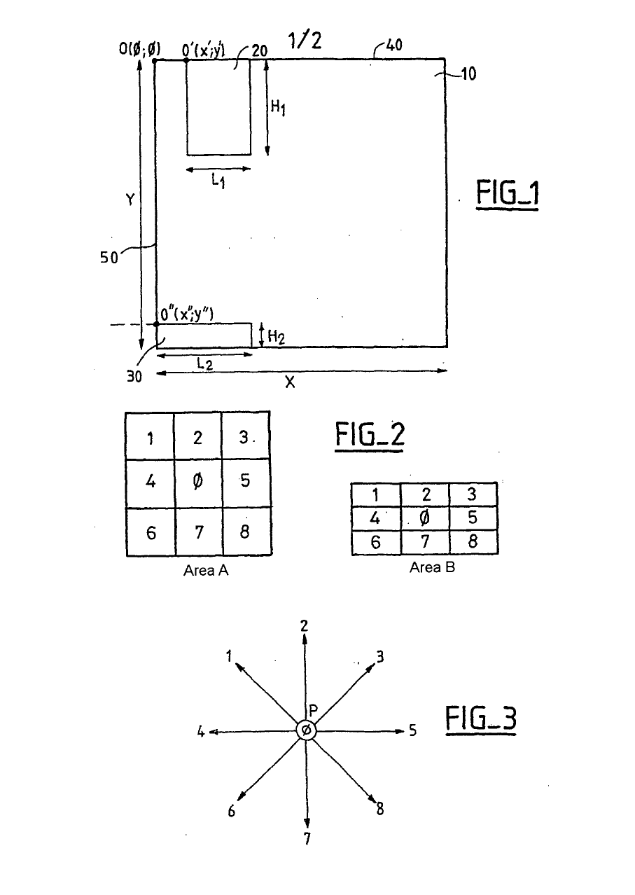

FIG. 2 represents two video areas defined in accordance with the invention.

FIG. 3 represents positioning video areas in two dimensions.

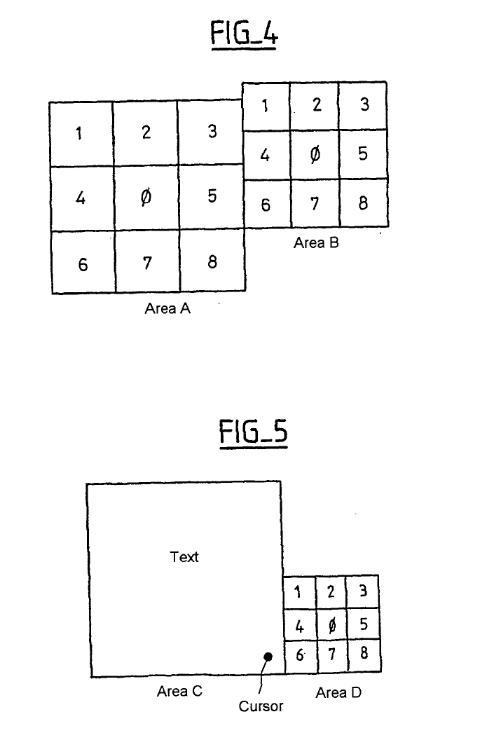

FIG. 4 represents one example of positioning one video area relative to another video area.

FIG. 5 represents one example of positioning one video area relative to another area comprising a cursor.

FIG. 2 represents two video areas A and B.

The two areas are divided into nine portions of equal size. The nine portions are numbered from 0 to 8 with the top left-hand portion numbered 1, the top middle portion numbered 2, the top right-hand portion numbered 3, the middle left-hand portion numbered 4, the central portion of the area numbered 0, the bottom left-hand portion numbered 6, the bottom middle portion numbered 7, and the bottom right-hand portion numbered 8.

In one embodiment of the invention, if a plurality of areas must be displayed, the areas are divided and numbered as described above. This embodiment of the invention is not unique.

FIG. 3 represents positioning video areas in two dimensions.

To characterize the location of two areas (a first area and a second area) relative to each other, a location relation is used. The second area is positioned relative to the first area, referred to as the reference area, in accordance with this location relation. This location relation is defined by a plurality of criteria including a positioning direction along one of the various axes that intersect at the same point P. These axes have four different directions, each having two opposite senses. The vertical direction has two senses: upward (position 2) and downward (position 7). The horizontal direction has two senses: leftward (position 4) and rightward (position 5). The direction at 45° to the vertical in the clockwise sense has two senses: upward (position 1) and downward (position 8). The direction at 45° in the clockwise sense to the horizontal has two senses: upward (position 3) and downward (position 6). Finally, position 0 means that the two areas are aligned by their middle.

Thus nine possible positions are defined.

FIG. 4 represents an example of positioning one video area relative to another.

In this example, in which the location relation between the two areas A and B is explained, the area A is the reference area.

A reference point in the area A is determined relative to the reference area by a first location relation: in this example, the reference point is the portion 5 of the reference area A. This portion 5 is determined in accordance with the example described with reference to FIG. 2.

The area B is positioned relative to the area A relative to a second location relation. The second location relation is such that the portion 5 of the area A touches the portion 6 of the area B in the positioning direction 5.

Thus the area B is placed relative to the area A so that its portion 6 is horizontally to the right of the portion 5 of the area A.

FIG. 5 represents one example of positioning one video area relative to another area comprising a cursor.

In this example, the video area D is positioned relative to the video area C containing a cursor. This area C can display data such as a text or a picture, for example. The cursor is at the end of the text, for example.

The area C is the reference area and the reference point is the cursor. The first location relation of the reference point relative to the area C is defined by the last character in the bottom right-hand corner of the text.

The area D is positioned relative to the area C relative to a second location relation. This second location relation is such that the cursor of the area C touches the portion 6 of the area B in the positioning direction 5.

Thus the area D is placed relative to the area C so that its portion 6 is horizontally to the right of the cursor of area A.

1. A method of displaying data on a display screen including at least two areas for displaying data, namely a first area and a second area (area A, area B), the position of the second area being determined relative to a reference point according to a first location relation, which method is characterized in that said reference point is determined relative to said first area in accordance with a second location relation.

2. A method according to claim 1, wherein the first area is a unique reference area.

3. A method according to either claim 1 or claim 2, wherein said second location relation is determined relative to the reference point in a given direction and a given sense.

4. A method according to claims 1 to 3, wherein:
said areas are divided into sub-areas,
the first location relation is defined relative to a sub-area of the first zone and the second location relation is defined relative to to a sub-area of the second area.

5. A method according to claim 4, wherein said sub-areas are polygons with the same surface area.

6. A method according to either claim 4 or claim 5, wherein said areas are divided into nine sub-areas.

7. A method according to any of claims 4, 5 or 6, wherein each of said sub-areas is labeled with a unique identifier.
